(19) United States
(12) Patent Application Publication
(10) Pub. No.: US 2012/0125380 A1
(43) Pub. Date: May 24, 2012

(54) SPRAY NOZZLE FOR USE WITH CONTAINER RINSING APPARATUSES

(76) Inventor: Todd Kemme, Holland, MI (US)

(21) Appl. No.: 13/228,771

(22) Filed: Sep. 9, 2011

Related U.S. Application Data
(60) Provisional application No. 61/381,314, filed on Sep. 9, 2010.

(51) Int. Cl. B08B 9/093

(52) U.S. Cl. 134/166 R

(57) ABSTRACT

A spray nozzle in combination with a container rinsing apparatus, the spray nozzle including a nozzle body having a coupler for associating the spray nozzle with the container rinsing apparatus, a neck extending from the coupler, the neck defining a sidewall, a central axis extending therethrough, an inlet formed in the coupler, a central port extending through the nozzle body, the central port providing a first path for fluid communication from the inlet of the coupler to an outlet formed in the neck, at least one secondary port disposed in spaced apart relation to the central port, the at least one secondary port providing a second path for fluid communication from the inlet of the coupler to an outlet formed in the at least one secondary port.

### CROSS-REFERENCE TO RELATED APPLICATION(S)

This application claims the benefit of U.S. Provisional Application No. 61/381,314, filed Sep. 9, 2010—which is hereby incorporated herein by reference in its entirety.

### BACKGROUND OF THE INVENTION

### 1. Field of the Invention

The present invention relates in general to spray nozzles for use with container rinsing apparatuses and, more particularly, to spray nozzles for use with container rinsing apparatuses that disperse fluid to effectively rinse the inner surfaces of containers.

Spray nozzles for container rinsing apparatuses have been known in the art for years and are the subject of several patents including: U.S. Pat. No. 2,634,734, entitled “Keg washing apparatus,” U.S. Pat. No. 3,495,291, entitled “Container rinser apparatus,” U.S. Pat. No. 3,737,108, entitled “Spray Nozzle,” U.S. Pat. No. 5,419,348, entitled “Nozzle spray assembly,” and U.S. Patent Application Publication No. 2004/0168711, entitled “Container rinsing apparatus and method,” all of which are hereby incorporated herein by reference in their entirety including the references cited therein.

U.S. Pat. No. 2,634,734, appears to be directed to a beer keg washer and it is one object of the invention to provide a washer of this character and construction that kegs may be fed into the front end of the apparatus and then transferred in step-by-step movements into position for spraying of caustic cleansing fluid.

U.S. Pat. No. 3,495,291, appears to disclose an apparatus that includes a driven threaded worm and means for supplying upright cylindrical containers to the worm for engagement therewith and movement therealong. The containers are moved by the worm for injecting streams of fluid into such containers for rinsing action.

U.S. Pat. No. 3,737,108, appears to disclose an airless spray nozzle for spraying a fan or elliptically shaped pattern within which there is a predetermined uneven distribution of sprayed material. The nozzle has an orifice defined by the intersection of a single V-shaped cut through the end of the nozzle into an asymmetrically positioned conically shaped dome in the interior of the nozzle.

U.S. Pat. No. 5,419,348, appears to disclose an automatic bottle washing machine, a nozzle spray system for spraying an internal bottom surface of a bottle or container that is rotatable about its central vertical axis. The nozzle spray system includes a nozzle body having a centralized bore for receiving pressurized fluid, a plurality of discharge orifices located in a staggered, spaced apart pattern on the surface of the nozzle body, and a plurality of elongated microbores to connect a respective one of the plurality of discharge orifices to the centralized bore. When the nozzle body is positioned within an invertedly positioned bottle, cleaning fluid is discharged from the plurality of discharge orifices in well focused jets toward adjacent regions of the internal bottom surface of the bottle. Simultaneously, the bottle is caused to rotate about its vertical axis so that the combination of the rotation of the bottle and the impingement of the well focused fluid jets enable the mechanical peeling off of the residual layers of grime located at the bottom surface of the bottle.

U.S. Patent Application Publication No. 2004/0168711, appears to disclose a container rinsing apparatus and method of rinsing a container that includes a nozzle positioned to spray liquid at a particular spray angle toward the interior surface of the container when the top surface of the container depresses a base cover of the rinsing apparatus. The rinsing apparatus is capable of completely rinsing virtually any shape of container without requiring manipulation of the container relative to the rinsing device during rinsing. When the container is positioned to engage the rinsing apparatus, the nozzle is closer to the open end of the container than the closed end.

While spray nozzles for use with container rinsing apparatuses have been known in the art for years, issues associated with deficient or incomplete spray patterns, high operational flow rates, high fluid use, and the like remain problematic. To be sure, spray nozzles utilized with common container rinsing apparatuses often fail to produce spray patterns capable of sufficiently contacting the inner surfaces of containers, especially beverage containers having complex geometrical configurations. Additionally, most common container rinsing apparatuses operate at high flow rates (e.g., 30 PSI and above), which not only results in excessive use of rinsing fluids but also increased energy consumption by the container rinsing apparatus having to produce higher flow rates.

Therefore, it is an object of the present invention to provide spray nozzles for use with container rinsing apparatuses that reduce and/or eliminate the aforementioned drawbacks associated with presently available spray nozzles for use with container rinsing apparatuses.

These and other objects of the present invention will become apparent in light of the present specification, claims, and drawings.

### SUMMARY OF THE INVENTION

In one embodiment, the present invention is directed to a spray nozzle in combination with a container rinsing apparatus, the spray nozzle including: (a) a nozzle body having: (i) a coupler for associating the spray nozzle with the container rinsing apparatus; (ii) a neck extending from the coupler, the neck defining a sidewall; and (iii) a central axis extending therethrough; (b) an inlet formed in the coupler; (c) a central port extending through the nozzle body, the central port providing a first path for fluid communication from the inlet of the coupler to an outlet formed in the neck; (d) at least one secondary port disposed in spaced apart relation to the central port, the at least one secondary port providing a second path for fluid communication from the inlet of the coupler to an outlet formed in the at least one secondary port; and (e) wherein the neck extends from the coupler in such a way that fluid exiting the at least one secondary port contacts at least a portion of the sidewall of the neck to redirect fluid exiting the at least one secondary port upwardly and away from the central axis.

In an additional embodiment, the neck is upwardly flared towards a terminal end, wherein the terminal end includes the outlet formed in the neck.

In another embodiment, the sidewall of the neck extends at an angle relative to the central axis.

In yet another embodiment, the neck extends from the coupler forming an arcuate transitional region.

In accordance with the present disclosure, the at least one secondary port extends through at least a portion of the arcuate transitional region such that an outlet of the at least one secondary port is defined by an outer surface of the arcuate transitional region.

In an additional embodiment, at least a portion of an inner sidewall of the at least one secondary port is axially aligned with the sidewall of the neck.

In an alternative embodiment, an outer peripheral edge of a top portion of the neck extends from the central axis further than the outer peripheral edge of the at least one secondary port.

In another embodiment, the outlet formed in the neck is substantially conical.

In yet another embodiment, the outer peripheral edge of the neck is substantially rounded.

In an additional embodiment, the outer peripheral edge of the neck is substantially chamfered.

In yet another embodiment, the central port extends through the nozzle body substantially in axial alignment with the central axis.

In one additional embodiment, the central port includes a reduction positioned between the inlet formed in the coupler and the outlet formed in the neck to increase the flow rate of fluid communicating through the central port.

In yet another embodiment, the at least one secondary port extends substantially parallel to the central port.

In an alternative embodiment, the spray nozzle includes three secondary ports disposed in an arcuate pattern around the central port, wherein each secondary port is radially spaced apart from adjacent secondary ports at an angle.

In an additional embodiment, the container rinsing apparatus includes at least one rinsing fluid source holding the rinsing fluid, at least one path for the communication of the rinsing fluid from the rinsing fluid source and the spray nozzle, and at least one pump for communicating the rinsing fluid from the rinsing fluid source to the spray nozzle.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

The invention will now be described with reference to the drawings wherein:

FIG. 1 of the drawings is a front elevational view of a container rinsing apparatus in combination with a spray nozzle;

FIG. 2 of the drawings is a perspective view of the spray nozzle;

FIG. 3 of the drawings is a cross-sectional view of the spray nozzle of FIG. 2; and

FIG. 4 of the drawings is a top plan view of the spray nozzle of FIG. 3.

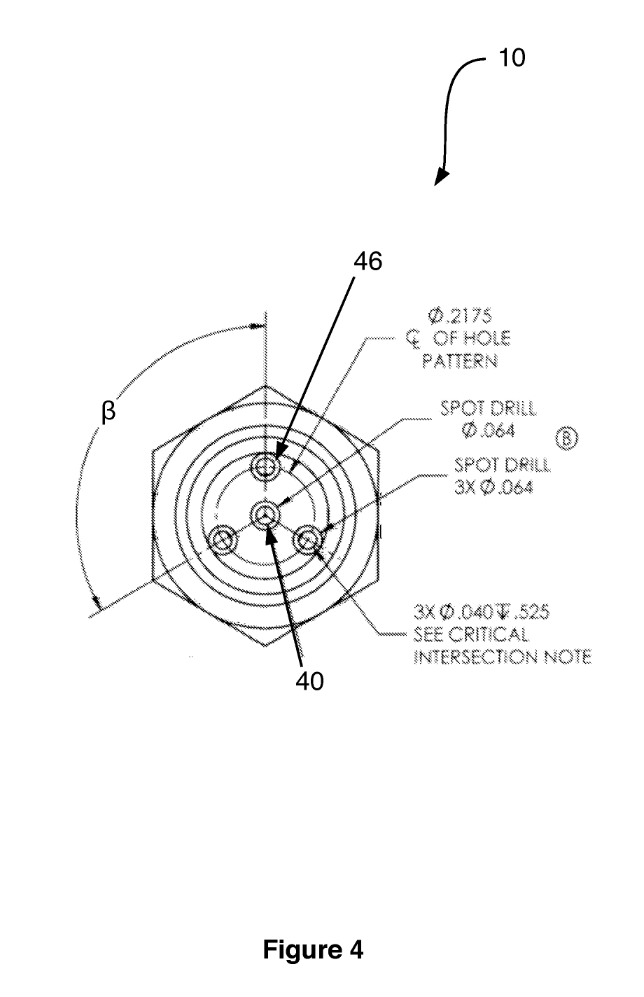

Additional drawings of the present invention are provided in Appendix A.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

Generally speaking, the present disclosure is directed to a spray nozzle for use with container rinsing apparatuses utilized to rinse containers with a fluid before the containers are filled with a product, such as a beverage. The spray nozzle is adapted to deliver a multi-directional spray pattern of fluid that contacts the inner surfaces of the containers.

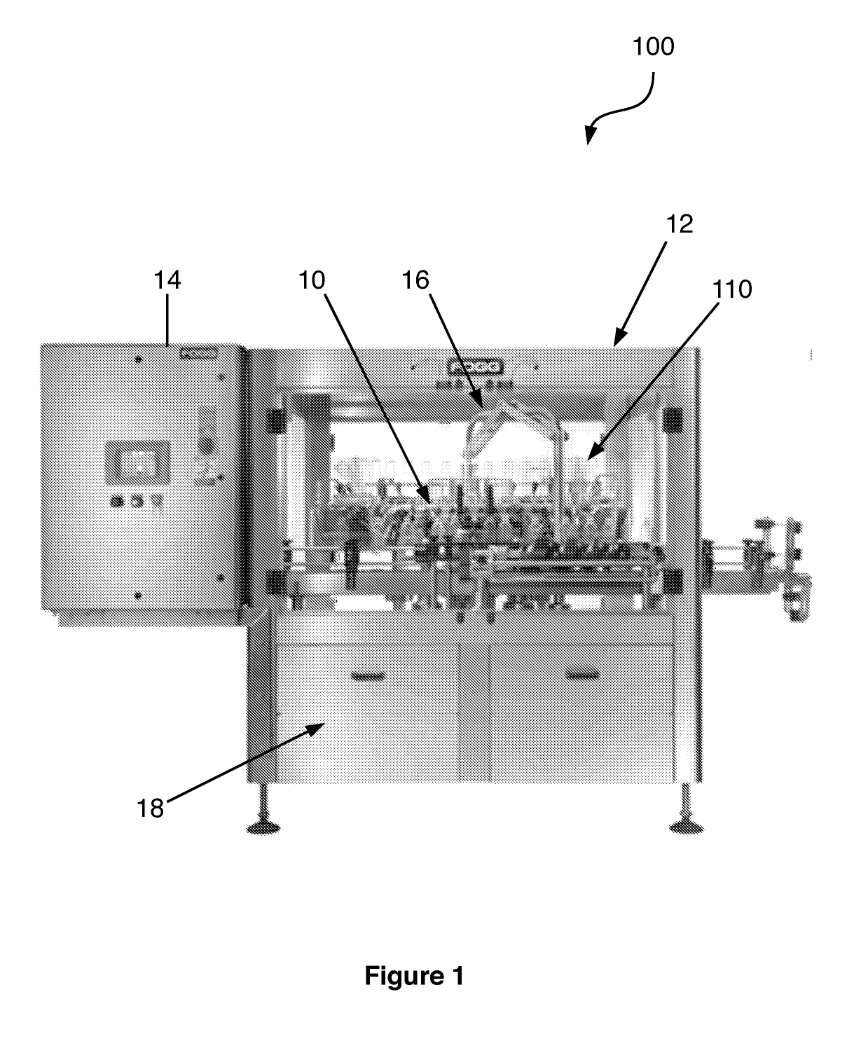

Referring now to the drawings and to FIG. 1 in particular, an exemplary system 100 for rinsing beverage containers 110 is shown. System 100 includes spray nozzle 10 in combination with container rinsing apparatus, hereinafter referred to as apparatus 12. Apparatus 12 may include fluid source 14 for retaining a rinsing fluid, path 16 for the communication of the fluid from fluid source 14 to spray nozzle 10, and pump 18 for communicating the fluid from fluid source 14 to spray nozzle 10 via path 16. Generally speaking, fluid source 14 may include a reservoir, a bladder, and a tank—just to name a few. Path 16 may include any number of components such as hoses, pipes, and the like adapted to operatively couple to spray nozzle 10.

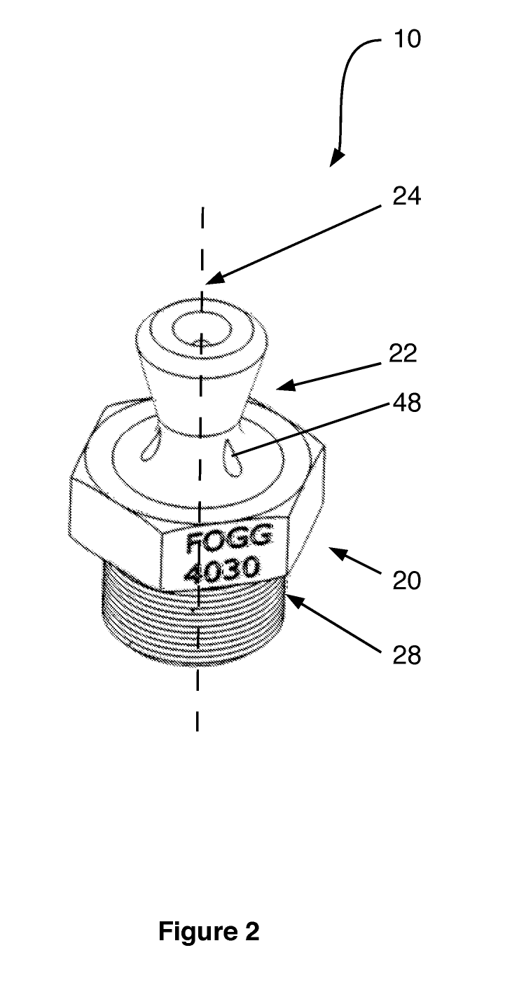

Referring now to FIG. 2, spray nozzle 10 includes a nozzle body having coupler 20 and neck 22 extending from coupler 20 along central axis 24. In general, spray nozzle 10 may be fabricated from a strong and resilient material such as stainless steel, although other types of materials commonly utilized in the container processing industries may be utilized in accordance with the present invention. In one embodiment, coupler 20 includes threaded outer surface 28 adapted to operatively couple spray nozzle 10 to path 16 (FIG. 1) of apparatus 12. It will be understood that coupler 20 may include threads on the inner surface of inlet 28 in addition to, or in place of, threads on the outer surface of coupler 20. Other types of operative couplings include, but are not limited to, compression fittings, quick connections, and the like.

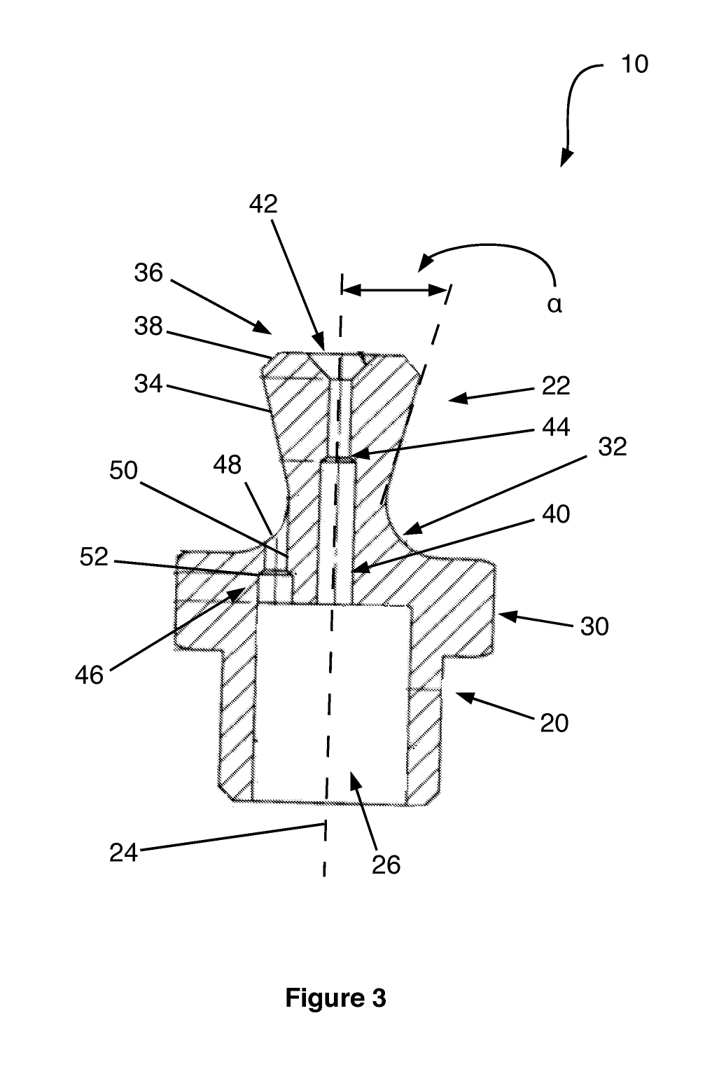

Referring now to FIG. 3, coupler 20 may also include inlet 28 formed therein for receiving fluid from path 16. Coupler 20 may also include hexagonal collar 30 that functions as a mechanical engagement for securing coupler 20 to path 16. Hexagonal collar 30 extends from coupler 20 to form a flange, which functions as a stop to prevent over-tightening of spray nozzle 10 to path 16.

Neck 22 extends from coupler 20 to form transitional region 32, which in some exemplary embodiments is substantially hyperboloid in shape. It will be understood that transitional region 32 defines a radius that may vary according to design requirements. In one embodiment, the depth of the radius of transitional region 32 may be varied such that the radius is tangent the secondary ports, as will be discussed in greater detail below. Neck 22 extends from coupler 20 to define sidewall 34 that extends at angle α relative to central axis 24. That is, neck 22 is flared from a smaller diameter proximate coupler 20 to a larger diameter proximate terminal end 36 of neck 22. It will be understood that angle α may include any number of angles between approximately five to fifty degrees relative to central axis 24. According to some embodiments, neck 22 may include chamfered edge 38 or a rounded edge (not shown) that substantially minimizes turbulent flow and/or tearing of fluid around the edge of neck 22, as will be discussed in greater detail below.

Spray nozzle 10 may include central port 40 extending substantially in axial alignment with central axis 24. Central port 40 provides a first path for the communication of fluids from inlet 28 of coupler 20 to outlet 42 formed in terminal end 36 of neck 22. In some embodiments, outlet 42 may have an outwardly widening conical configuration to modify the diameter of the stream of fluid flowing from outlet 42. It will be understood that the shape of outlet 42 may vary according to design requirements such as spray pattern, operating pressure, and the like. Central port 40 may include reduction 44 that increases the flow rate of fluid communicating through central port 40. Reduction 44 may be disposed along central port 40 at any distance along the length thereof.

Spray nozzle 10 includes at least one, and in some embodiments, three secondary ports 46. Each secondary port 46 may extend through the nozzle body substantially parallel to central port 40 and provides a second path or paths for communication of fluids from inlet 28 of coupler 20 to outlet 48 formed in the terminal end of secondary port 46. Moreover, secondary ports 46 are spaced apart from central port 40 at a predetermined distance and are disposed in a substantially arcuate pattern around central port 40. It will be understood that in some exemplary embodiments, each secondary port 46 is radially spaced apart from the other adjacent secondary ports 46 at an angle β. In some embodiments angle β may be approximately 120 degrees.

Secondary ports 46 extend through transitional region 32 such that the peripheral edge of outlet 48 conforms to the shape of transitional region 32. Moreover, a portion of inner sidewall 50 of outlet 48 may be substantially axially aligned with sidewall 34 of neck 22. As such, outlet 48 is tear-shaped in configuration (see FIG. 2). Because inner sidewall 50 of outlet 48 is axially aligned with sidewall 34, the fluid exiting outlet 48 is directed along sidewall 34 substantially minimizing turbulent flow and/or tearing of fluid exiting outlet 48. Additionally, the configuration of outlet 48 substantially prevents fluid from exiting outlet 48, abruptly deflecting off of sidewall 34, and disrupting the spray pattern. Secondary port 46 may also include reduction 52 that increases the flow rate of fluid communicating therethrough. The diameter of reduction 52 may vary according to design requirements.

In operation, spray nozzle 10 is operatively connected to path 16 of apparatus 12. Beverage containers 110 are positioned upside down over spray nozzle 10. According to some exemplary embodiments, spray nozzle 10 may be at least partially inserted into an opening of beverage containers 110.

Pump 18 communicates fluid through path 16 and into inlet 28 of coupler 20. Fluid is then directed through spray nozzle 10 via central port 40, exiting outlet 42 to form a substantially linear stream of fluid that extends along central axis 24. Fluid is also directed through secondary ports 46 exiting outlets 48. The fluid travels along sidewall 34 of neck 22 and off the same to form a substantially fan-shaped stream of fluid that communicates upwardly and outwardly from central axis 24 at an angle substantially equal to angle α of sidewall 34.

It will be understood that when spray nozzle 10 includes three secondary ports 46, the fluid exiting outlets 48 form a substantially continuous annular spray pattern when the flow rate of the fluid communicating through spray nozzle 10 reaches a predetermined velocity. As the annular spray pattern travels upwardly, the fluid is dispersed or atomized in such a way that the inner surfaces of beverage containers 110 are contacted by the fluid to rinse the same. Moreover, spray nozzle 10 efficiently and effectively rinses beverage containers at fluid pressures of between 5 and 80 PSI.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A spray nozzle in combination with a container rinsing apparatus, the spray nozzle comprising:
a nozzle body having:
a coupler for associating the spray nozzle with the container rinsing apparatus;
a neck extending from the coupler, the neck defining a sidewall; and
a central axis extending therethrough;
an inlet formed in the coupler;
a central port extending through the nozzle body, the central port providing a first path for fluid communication from the inlet of the coupler to an outlet formed in the neck;
at least one secondary port disposed in spaced apart relation to the central port, the at least one secondary port providing a second path for fluid communication from the inlet of the coupler to an outlet formed in the at least one secondary port; and
wherein the neck extends from the coupler in such a way that fluid exiting the at least one secondary port contacts at least a portion of the sidewall of the neck to redirect fluid exiting the at least one secondary port upwardly and away from the central axis.

2. The combination according to claim 1, wherein the neck is upwardly flared toward a terminal end thereof.

3. The combination according to claim 2, wherein the sidewall of the neck extends at an angle relative to the central axis.

4. The combination according to claim 1, wherein the neck extends from the coupler in such a way that an arcuate transitional region is formed therebetween.

5. The combination according to claim 4, wherein the at least one secondary port extends through at least a portion of the arcuate transitional region such that an outlet of the at least one secondary port is defined by an outer surface of the arcuate transitional region.

6. The combination according to claim 5, wherein at least a portion of an inner sidewall of the at least one secondary port is axially aligned with the sidewall of the neck.

7. The combination according to claim 5, wherein an outer peripheral edge of a terminal end of the neck extends from the central axis further than the outlet of the at least one secondary port.

8. The combination according to claim 1, wherein the outlet formed in the neck is substantially conical.

9. The combination according to claim 1, wherein the outer peripheral edge of the neck is substantially rounded.

10. The combination according to claim 9, wherein the outer peripheral edge of the neck is substantially chamfered.

11. The combination according to claim 1, wherein the central port extends through the nozzle body substantially in axial alignment with the central axis.

12. The combination according to claim 1, wherein the central port includes a reduction positioned between the inlet formed in the coupler and the outlet formed in the neck to increase the flow rate of fluid communicating through the central port.

13. The combination according to claim 12, wherein fluid exiting the central port extends in a substantially linear pattern.

14. The combination according to claim 1, wherein the at least one secondary port extends through the nozzle body substantially parallel to the central port.

15. The combination according to claim 14, wherein fluid exiting the at least one secondary port is directed along at least a portion of the sidewall of the neck and extends from the neck in a substantially fan-shaped pattern.

16. The combination according to claim 1, wherein the spray nozzle includes three secondary ports disposed in an arcuate pattern around the central port.

17. The combination according to claim 16, wherein each secondary port is radially spaced apart from adjacent secondary ports at an angle.

18. The combination according to claim 17, wherein fluid exiting each of the secondary ports is directed along at least a portion of the sidewall of the neck and extends from the neck in a substantially fan-shaped pattern, further wherein the substantially fan-shaped patterns join to form a substantially annular shaped pattern when the fluid flowing through the spray nozzle reaches a predetermined velocity.

19. The combination according to claim 1, wherein the container rinsing apparatus including:
at least one rinsing fluid source holding the rinsing fluid;
at least one path for the communication of the rinsing fluid from the rinsing fluid source to the spray nozzle; and
at least one pump for communicating the rinsing fluid from the rinsing fluid source to the spray nozzle.

20. A spray nozzle in combination with a container rinsing apparatus, the spray nozzle comprising:
a nozzle body having:
a coupler for associating the spray nozzle with the container rinsing apparatus;
a neck extending from the coupler, the neck defining a sidewall; and
a central axis extending therethrough;
an inlet formed in the coupler;
a central port extending through the nozzle body, the central port providing a first path for fluid communication from the inlet of the coupler to an outlet formed in the neck;
three secondary ports disposed in spaced apart relation to the central port, the at least one secondary port providing a second path for fluid communication from the inlet of the coupler to an outlet formed in the at least one secondary port, wherein each secondary port is radially spaced apart from adjacent secondary ports at an angle; and
wherein the neck extends from the coupler in such a way that fluid exiting the at least one secondary port contacts at least a portion of a sidewall of the neck to redirect fluid exiting the at least one secondary port upwardly and away from the central axis.
